(19) United States
(12) Patent Application Publication
(10) Pub. No.: US 2022/0410057 A1
(43) Pub. Date: Dec. 29, 2022

(54) MACRO ANTI-FOULING SCREEN FUNCTIONING IN MULTI-DIRECTIONAL FLOW

(71) Applicant: EMERGING ACQUISITIONS, LLC, Eugene, OR (US)

(72) Inventors: Kienan Cree BROTHERTON, Eugene, OR (US); Jonathan Thomas BROOKS, Lebanon, TN (US); Alexander Elazar SEIDEL, Eugene, OR (US); Seth Lawrence MACKOVJAK, Eugene, OR (US)

(73) Assignee: EMERGING ACQUISITIONS, LLC, Eugene, OR (US)

(21) Appl. No.: 17/771,437

(22) PCT Filed: Oct. 30, 2020
(86) PCT No.: PCT/US20/58199

§ 371 Date: Apr. 22, 2022

Related U.S. Application Data
(60) Provisional application No. 62/930,496, filed on Nov. 4, 2019.

(51) Int. Cl. B01D 46/71; B01D 46/10; B01D 46/00; B01D 46/46

(52) U.S. Cl. CPC B01D 46/71; B01D 46/10; B01D 46/0039; B01D 46/46; F04F 1/02

(57) ABSTRACT

Disclosed embodiments include an apparatus for reducing contamination or obstruction of a multi-directional flow filtration system. As one example, a scalper that is to be employed on a multi-directional flow filtration system comprises a body and a set of scalping walls forming a plurality of helical chambers, the set of scalping walls helically extending along at least a portion of an interior of the body in a longitudinal direction. In this way, the plurality of helical chambers may enable the multi-directional flow filtration system to passively scalp contaminants in a manner that improves overall operation of the multi-directional flow filtration system. Other embodiments may be described and/or claimed.

### CROSS-REFERENCE TO RELATED APPLICATION

This application claims the priority benefit of the earlier filing date of U.S. Provisional Application No. 62/930,496, filed Nov. 4, 2019, which is hereby incorporated herein by reference in its entirety.

### TECHNICAL FIELD

Embodiments herein relate to the field of scalping of irregular contamination within high flow, high vacuum systems, and more specifically, to an anti-fouling screen or scalping section capable of segregating material of a smaller cross-sectional area than an aperture of the screen.

### BACKGROUND

Robotic pick and place automation can be used in a number of applications to speed up a process of picking objects up and placing the objects in new locations. As one example of a pick and place application, a vacuum generator can be paired with a suction cup that is used to hold an object while the object is moved.

In many examples, such vacuum generators may be protected via an air filtration system. While an air filtration system may reduce effectiveness of the pick and place application, such systems may be needed to preserve integrity and efficiency of the vacuum generators used in the application. There are many different types of air filters used in industry today, yet they all may succumb to similar limitations, including but not limited to a loss of vacuum flow as the screened particle size decreases or surface area increases from the filters micron rating.

Vacuum-driven pick and place applications may comprise robotic systems used in manufacturing environments. Such applications may allow for predictable and consistent material presented to the robotic system to be handled. In examples where the material presented to the robotic system is consistent and predictable, a single micron rated filter may be used due to a low risk that the filter may be presented with an object that can instantly reduce the effectiveness of the ability of the particular vacuum system to grasp objects.

However, reliance on a single micron rated filter may not be sustainable for pick and place applications presented with material with large size deviations. Such applications have a risk of drawing in contamination that can block, bind, clog, etc., the filter. One example solution is to rely on an in line screen placed at the end effector or suction cup, which may prevent contamination from entering the system to begin with, but includes an added risk of the contaminating material wrapping or entangling in the screen.

Material wrapping and entanglement may be amplified as the vacuum flow is reversed as a means of detaching objects from the end effector. For example, the flow reversal may be produced by depressurizing the system as the system normalizes to atmospheric pressure. In other examples, the system may be pressurized to reduce evacuation time, which may result in further entangling of contamination wrapped in the screening device.

One such industry that operates with a large size deviation of material and which encounters contamination that may be adverse to operation of the particular pick and place system, includes robotic pick and place applications used in recycling facilities. Vacuum systems in such environments may regularly encounter contamination including but not limited to film, textiles, and string. Such items can at least partially, or even fully, block filters and/or wrap and entangle filtration screens. The inventors herein have recognized the above-mentioned issues, and have herein developed systems and methods to at least partially address them.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 illustrates an example multi-directional flow filtration system in accordance with various embodiments; FIG. 2 illustrates an example method for operating a multi-directional flow filtration system in accordance with various embodiments; FIG. 3 illustrates an example end effector with a scalping section in accordance with various embodiments; FIG. 4 illustrates an example end effector with a scalping section and a bypass port in accordance with various embodiments; FIG. 5 illustrates another example end effector with a scalping section that does not include a bypass port, in accordance with various embodiments; and FIG. 6 illustrates yet another example end effector with a plurality of scalping sections and a bypass port, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense. Various operations may be described as multiple discrete operations in turn, in a manner that may be helpful in understanding embodiments; however, the order of description should not be construed to imply that these operations are order-dependent. The description may use perspective-based descriptions such as up/down, back/front, and top/bottom. Such descriptions are merely used to facilitate the discussion and are not intended to restrict the application of disclosed embodiments.

Vacuum-driven pick and place systems may include an end effector screen, which is a screen included in a suction cup of the pick and place system. The screen is meant to prevent or reduce the likelihood of drawing material into the vacuum generator itself or otherwise clogging the vacuum-driven system. For example, high vacuum flow may draw in unintended objects including but not limited to film, strings, textiles, etc., that may be held to the end effector screen. Once an object or contamination is fixed to the end effector screen, the vacuum pressure may imbed the contamination into the screen. Then as the system depressurizes to release such an object, under conditions where the object or contamination is malleable, the object or contamination may further imbed into the screen, thereby resulting in an at least partially clogged grasping device (e.g., end effector or suction cup). As the system continues to operate, the vacuum and depressurization cycling may continue to imbed and entangle the contamination into the screen. An at least partially clogged grasping device may in turn reduce the system's usable vacuum flow, thereby reducing an ability of the system to acquire (e.g., grasp or hold) objects, and degrading operation of the vacuum-driven pick and place system. Accordingly, embodiments discussed herein reduce contamination or obstruction of vacuum-driven pick and place systems. It may be understood that embodiments herein are not limited to pick and place systems, but encompass a wide variety of applications pertaining to flow filtration systems, including but not limited to multi-directional flow filtration systems, aspirators, venturi separators, and the like.

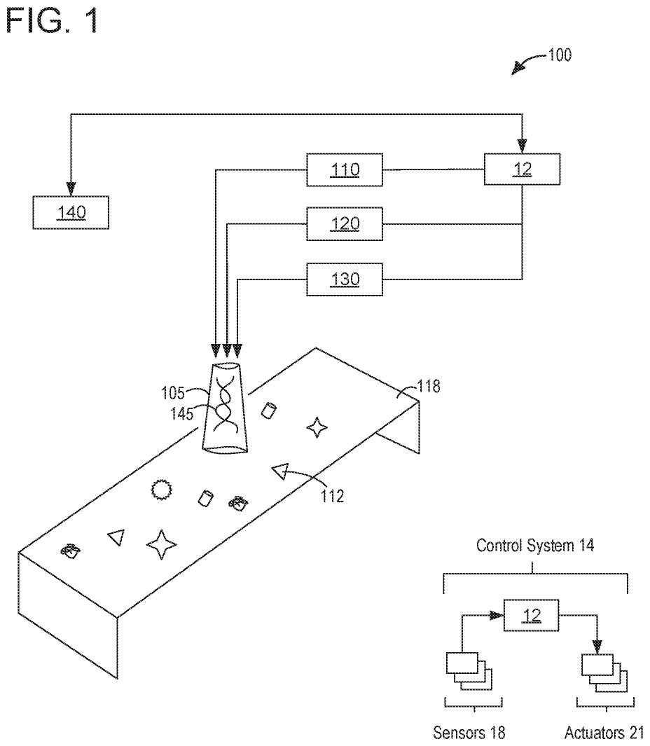

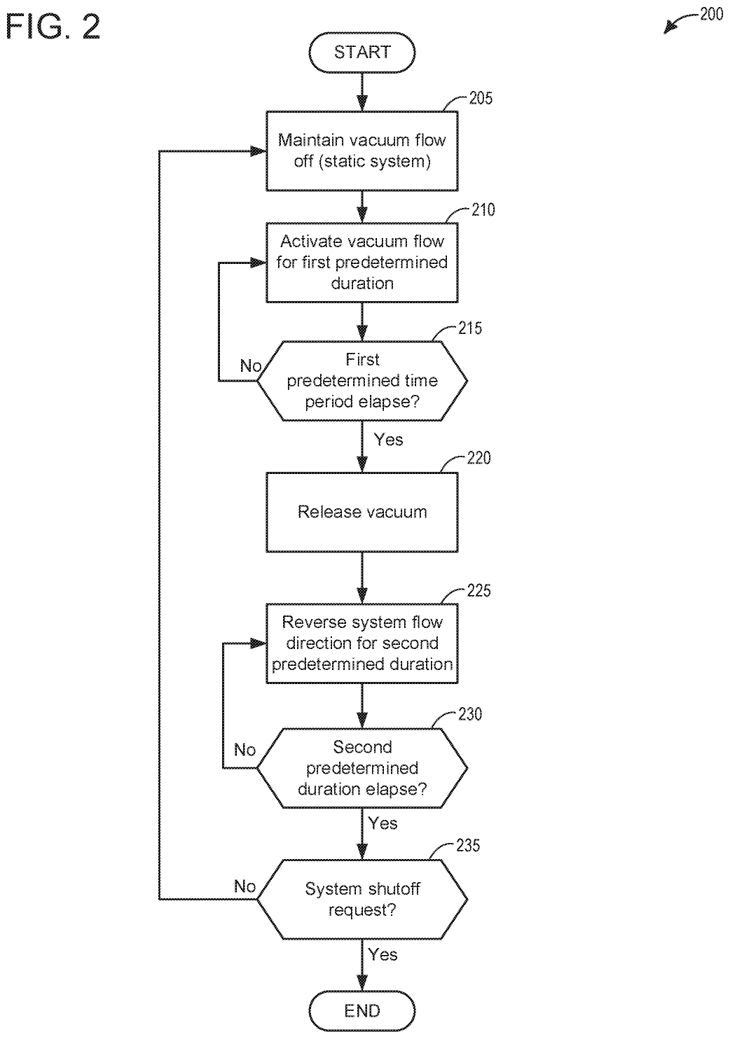

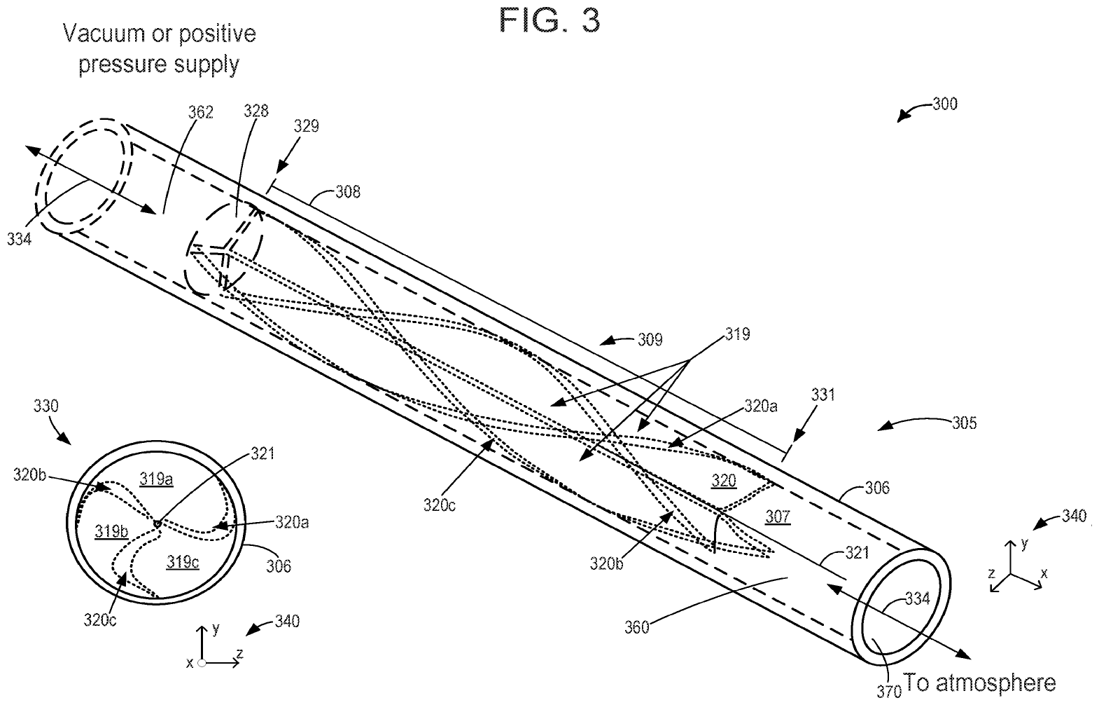

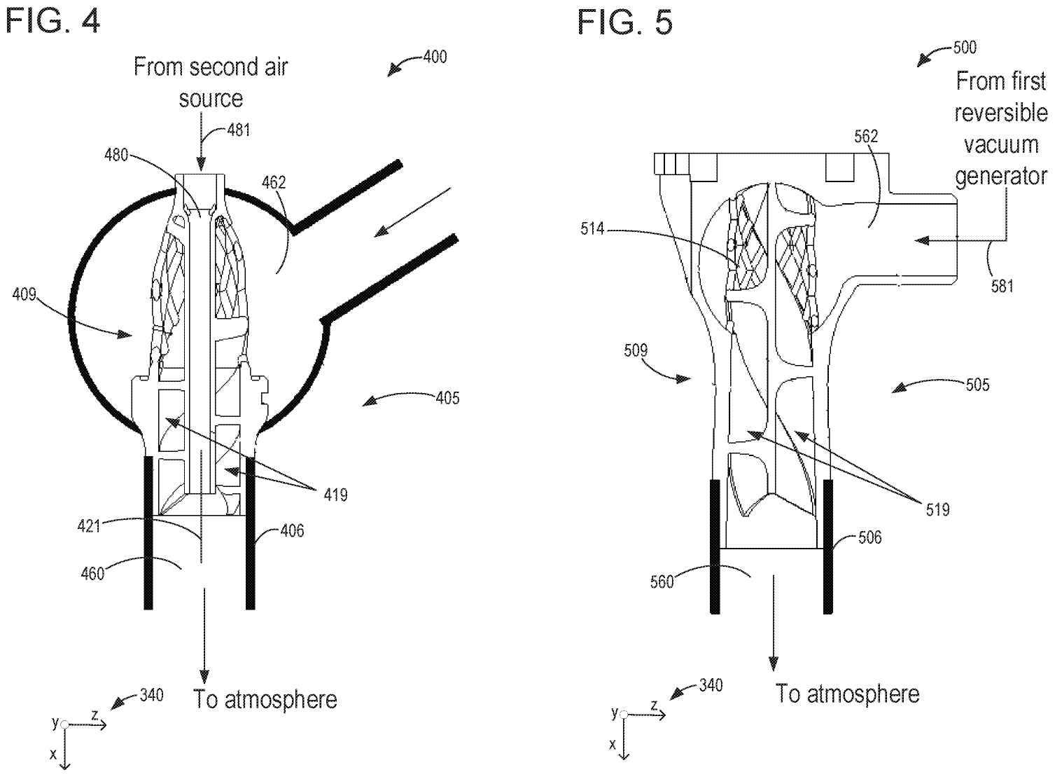

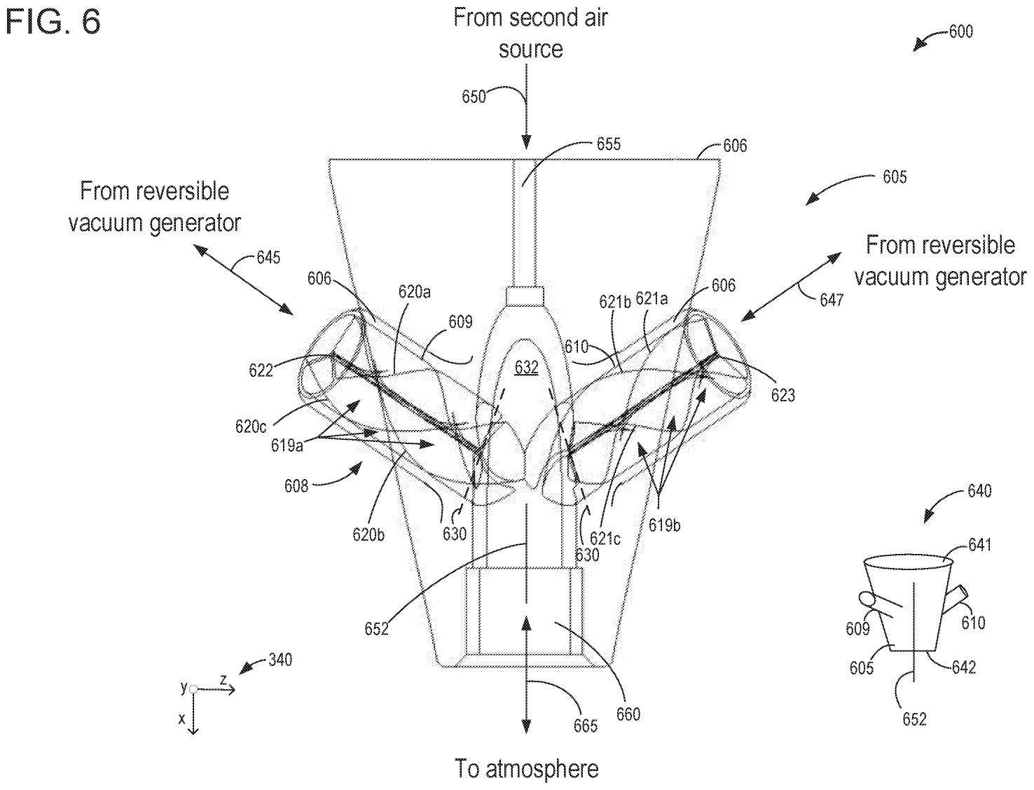

Turning now to the Figures, FIG. 1 illustrates an example multi-directional flow filtration system 100 according to various embodiments. FIG. 1 depicts multi-directional flow filtration system 100 illustratively as a vacuum-driven pick and place system, as one embodiment of the present disclosure. Such a multi-directional flow filtration system 100 may include one or more end effectors 105. In the field of robotics, an “end effector” (also known as end-of-arm tooling (EOAT)) is a portion of a robot that interacts with an environment outside of, or separate from, the robot. Usually, this excludes mobility elements such as wheels, tracks, or humanoid legs/feet. For example, an end effector of a robotic kinematic chain may be a portion of the robot that has an attached tool including impactive tools that physically grasp by direct impact upon an object 112 (e.g., jaws, claws, clamps, grippers, or the like), ingressive tools that pierce or physically penetrate the surface of an object 112 (e.g., pins, needles, or the like), astrictive tools that apply an attractive force(s) to the objects' 112 surface (e.g., vacuum or suction, magnetism, electroadhesion, or the like), contigutive tools that use direct contact for adhesion (e.g., glue, surface tension, freezing, or the like), and/or contactless tools that employ some force to bring the end effector and object 112 close to one another (e.g., Bernoulli grippers, electrostatic grippers and van der Waals grippers based on electrostatic charges, ultrasonic grippers, laser grippers, capillary grippers, or the like). According to various embodiments, the end effector 105 may comprise any means of grasping and releasing particular objects 112. In the following discussion, the end effector 105 is described as being or using a suction cup, however, any type of gripping mechanism may be used in various other embodiments.

In one example implementation, objects 112 may comprise materials for recycling, and multi-directional flow filtration system 100 may be used to select particular objects 112 for placement of the selected objects 112 in another location. For example, objects 112 may be positioned on platform 118, and multi-directional flow filtration system 100 may select particular objects 112 for removal from the platform 118 for placement in another location. The platform 118 may be a table, stand, conveyor belt, or some other element that can hold objects 112. Objects 112 may comprise non-uniform shapes, size, weight, material composition, etc. The multi-directional flow filtration embodiments of the present disclosure are not limited to recycling applications, and the embodiments herein may be used in any type of flow-filtration system. For example, the embodiments herein may be applicable to picking and placing small surface mount technology (SMT) components, picking and placing small stones/beads for jewelry making, picking and placing food items (e.g., cookies, chocolate or other food stuff in packages, and the like), vacuum cleaner technology (e.g., wet vacuum and/or dry vacuum technology), aspirators, venturi separators, among others.

Multi-directional flow filtration system 100 may include, or be part of a control system 14. The control system 14 is an interconnection of components forming a system configuration that provides a desired process response. In this embodiment, the control system 14 comprises a controller 12 that provides the logic and control instructions for the process, one or more sensors 18 that measure various physical properties, and one or more actuators 21 that change the state of the environment. The control system 14 may also include signaling means (not shown) that converts measurements from the sensor(s) 18 and/or instructions generated by the controller 12 into one or more signals that are then sent to other elements/components of the system. For example, the controller 12 may receive input data from the one or more sensors 18, process the input data, and trigger the actuators 21 in response to the processed input data based on instructions or code programmed therein corresponding to one or more routines, procedures, functions, methods, etc. The control system 14 may operate according to an open-loop system, closed-loop system, sequence control system, and/or a batch control system.

The controller 12 may comprise circuitry including, for example, one or more central processing units (CPU) including one or more processor cores, graphics processing units (GPU), programmable logic controllers (PLC), microprocessors, digital signal processors (DSP), one or more field-programmable gate arrays (FPGA), Application Specific Integrated Circuits (ASIC), or any suitable combination thereof. The circuitry of controller 12 may be coupled with or may include memory/storage devices and may be configured to execute instructions stored in the memory/storage to enable various applications, logic, etc., to run on the controller 12 and/or other elements of control system 14. In some embodiments, the controller 12 circuitry may be a special-purpose processor/controller to operate according to the various embodiments herein.

The sensors 18 include devices, modules, or subsystems whose purpose is to detect events or changes in an environment and send the information (e.g., sensor data) about the detected events to some other device, module, subsystem, etc., such as the controller 12. Examples of such sensors 28 include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras); light detection and ranging (LiDAR) sensors; proximity sensors (e.g., infrared radiation detector and the like), depth sensors, ambient light sensors, ultrasonic transceivers; microphones; etc.

The actuators 21 are devices, modules, or subsystems that change a state, position, and/or orientation, or move or control a mechanism or system, including external mechanisms/systems or the actuator(s) 21 themselves. The actuators 21 comprise electrical and/or mechanical elements that convert energy (e.g., electric current, moving air and/or liquid, etc.) into some kind of motion. The actuators 21 may be or include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 21 may be or include one or more electromechanical devices such as pneumatic actuators, hydraulic actuators, electro-hydrostatic actuators (EHA), electromechanical switches including electromechanical relays (EMRs), motors (e.g., DC motors, stepper motors, servomechanisms, linear motors, linear drives, etc.), and/or the like. The actuators 21 may be coupled with, and control the motion of other devices, such as valves, vacuum generators (e.g., venturi-based ejectors, blowers, etc.) pumps(e.g., vacuum pumps, suction pumps, hydraulic pumps, compressors, etc.), gears, wheels, thrusters, propellers, claws, clamps, hooks, an audible sound generator, and/or the like.

The signaling means (not shown) may include any element or combination of elements for conveying information/instructions to components of the control system 14. In some embodiments, the signaling means is or includes a suitable bus or interconnect (IX) technology, such as Peripheral Component Interconnect (PCI), PCI express (PCIE), industry standard architecture (ISA), Universal Serial Bus (USB), HyperTransport interconnect, Time-Triggered Protocol (TTP), FieldBus (e.g., IEC 61158) based IX such as PROFIBUS, Modbus, Common Industrial Protocol (CIP) IX, EtherNet Industrial Protocol (EtherNetIP), and/or the like. In some embodiments, the signaling means is or includes one or more network interface controllers that connect the controller 12 to other components/devices using a physical connection, which may be electrical (e.g., a “copper interconnect”) or optical, and which operates according to a wired network protocol such as Ethernet, Industrial Ethernet, Ethernet over USB, Controller Area Network (CAN), Local Interconnect Network (LIN), PROFINET, among many others. In some embodiments, the signaling means is or includes a radiofrequency transmitter (and receiver) or transceiver configured to enable communication with or over wireless networks using modulated electromagnetic radiation through a non-solid medium (e.g., over an air interface).

The embodiment shown by FIG. 1 also includes a reversible vacuum source 110 (e.g., first reversible vacuum generator 110), air source 120 (e.g., a second reversible vacuum generator or other high pressure air pump or compressor 120), movement system 130, and object detection system 140. These systems may be made up of various combinations of sensor(s) 18, actuator(s) 21, and controller 12. For example, the controller 12 communicatively coupled with various sensors 18 may comprise the object detection system 140. In another example, the controller 12 communicatively coupled with various actuators 21 may comprise the movement system 130. The reversible vacuum source 110 and the air source 120 may be actuators 21 themselves or may be operated (e.g., moved and controlled) by one or more actuators 21. Details of how reversible vacuum source 110 and air source 120 may be used will be described in greater detail infra.

In some embodiments, the controller 12 may send one or more signals to control the reversible vacuum generator 110 to operate in a vacuum-mode (e.g., drawing a negative pressure with respect to atmospheric pressure at end effector 105). When operating in the vacuum mode, the end effector 105 may pick up, “grasp”, or otherwise hold selected objects 112. The controller 12 may also send signal(s) to control the reversible vacuum generator 110 to be maintained in an off state. Additionally or alternatively, the controller 12 may send signal(s) to control the reversible vacuum generator 110 to reverse operation and supply a positive pressure with respect to atmospheric pressure to end effector 105. When the reversible vacuum generator 110 is off or is operating to provide a positive pressure to end effector 105, the end effector 105 may release objects 112 held by end effector 105. Accordingly, as discussed herein, end effectors may in some examples additionally/alternatively be referred to as suction cups, scalpers, or a suction mechanism.

In some embodiments, controller 12 may send signal(s) to control the air source 120 to provide a positive pressure to the end effector 105, for purposes which may include removing one or more objects 112 that are obstructing or adversely impacting operation of vacuum-driven pick and place system 100. In some implementations, the air source 120 may be capable of providing a higher positive pressure air supply than reversible vacuum generator 110.

Movement system 130 may include any combination of sensors (e.g., sensors 18), actuators (e.g., actuators 21), mechanical parts, etc., that enable vacuum-driven pick and place system 100 to manipulate movement of end effector 105, in order to allow end effector 105 to select, hold, move, and then release particular objects 112. As examples, sensors 18 may include one or more of pressure sensors, temperature sensors, ultrasonic sensors, light-based sensors (e.g., LIDAR), etc. As other examples, actuators 21 may include one or more of motors, valves (e.g., solenoid-actuated valves), switches, etc. Controller 12 may receive information from sensors 18 of movement system 130 and send signals to various actuators 21 of movement system 130, in order to control movement of at least end effector 105 of vacuum-driven pick and place system 100 and for control over the first vacuum generator 110 and/or air source 120.

Object detection system 140 may similarly include any combination of sensors 18, actuators 21, mechanical parts, etc., that enable object detection system 140 to communicate to controller 12 information pertaining to objects 112 (e.g., sensor data representing detected objects 112) for selection. In some examples, object detection system 140 may include one or more cameras for obtaining still images and/or video images. Object detection system 140 may obtain images corresponding to objects 112 on table 118, and may communicate such images to controller 12. In some examples, controller 12 may include software for recognizing particular objects, types of objects, objects of certain material, objects of certain dimensions, etc., and such information may be communicated to movement system 130 such that end effector 105 may be controlled to select particular items for placement in another location. In some examples, one or more of reversible vacuum generator 110 and air source 120 may be controlled at least in part based on information obtained by controller from one or more of object detection system 140 and movement system 130.

The controller 12 may be communicably coupled to reversible vacuum generator 110, air source 120, movement system 130 and/or object detection system 140 via one or more of a wireless network, wired network, or a combination of wired and wireless networks. Suitable networks include, but are not limited to, the Internet, a personal area network, a local area network (LAN), a wide area network (WAN) or a wireless local area network (WLAN), for example. Network devices (not shown) may include local area network devices such as routers, hubs, switches, or other computer networking devices.

Depicted at FIG. 1 is scalping section 145, included as a part of end effector 105. Scalping section 145 will be described in greater detail below. Briefly, scalping section 105 may comprise a plurality of helical chambers that function to hinder objects/materials from adversely impacting operation of the multi-directional flow filtration system (e.g., multi-directional flow filtration system 100 of FIG. 1). The helical nature of the individual chambers may enable such objects to be held by end effector 105 via scalping section 145 and then subsequently released without, for example, becoming entangled, embedded, or otherwise introduced into the multi-directional flow filtration system in a manner that may adversely impact operation of the multi-directional flow filtration system. It may be understood that each chamber of the plurality of helical chambers may be hollow.

While the example multi-directional flow filtration system depicted at FIG. 1 includes a control system, in other embodiments the multi-directional flow filtration system 100 may not include a control system 12 without departing from the scope of this disclosure. In one example, the multi-directional flow filtration system 100 may operate solely using pneumatic and/or mechanical means wherein the end effector 105 is coupled to an air cylinder that operates by drawing air through a body of the end effector 105, and hence, the plurality of helical chambers, and then expels air out by way of the plurality of helical chambers. Other control mechanisms may be used in other embodiments.

Turning to FIG. 2, a flow chart for a method 200 for controlling a multi-directional flow filtration system 100 according to various embodiments, is shown. Method 200 may be stored as executable instructions in non-transitory memory and executed by a processing device, such as controller 12 depicted in FIG. 1. Method 200 is described as being performed by the controller 12 of FIG. 1 with reference to the components depicted in FIG. 1, though it should be understood that the method 200 may be applied to other systems and performed by other components/devices without departing from the scope of this disclosure.

Method 200 begins at operation 205, where the controller 12 maintains the vacuum flow in an off state. For example, the controller 12 may command the reversible vacuum generator 110 to an off state so that the reversible vacuum generator is not drawing a vacuum via the scalper 105 (e.g., end-effector 105, or suction cup 105, or suction mechanism 105).

At operation 210, the controller 12 commands the reversible vacuum generator 110 to draw a vacuum via the scalper 105 of the multi-directional flow filtration system 100, for a first predetermined time duration. In one example, the first predetermined time duration may comprise 300 milliseconds, however in other examples the first predetermined time duration may be less than or greater than 300 milliseconds. In another example, the first time duration may be based on the type(s) of object(s) 112 detected by the object detection system 140 where the first time duration is longer for some types of objects 112 than for other types of objects 112. The first time period may be application specific and may vary from embodiment to embodiment.

At operation 215, the controller 12 determines whether the first predetermined time duration has elapsed. If not, then the controller 12 returns to operation 210 to continue or maintain the vacuum flow or the reversible vacuum generator 110 maintains the vacuum-mode, wherein a negative pressure is communicated to the scalper or scalpers of the multi-directional flow filtration system 100.

Responsive to the first predetermined time duration elapsing at operation 215, controller 12 proceeds to operation 220. At operation 220, controller 12 includes releasing the vacuum thereby allowing pressure within the scalper 105 to return to atmospheric pressure. Releasing the vacuum may include commanding the reversible vacuum generator 110 to transition to an off state, for example.

Subsequent to releasing the vacuum 110, the controller 12 proceeds to operation 225 to reverse the system flow direction for a second predetermined duration. In one example, the second predetermined duration may be 100 milliseconds. However, in other examples the second predetermined duration may be less than 100 milliseconds or greater than 100 milliseconds without departing from the scope of this disclosure. In another example, the second time duration may be the same as the first time duration. In another example, the second time duration may be based on the type(s) of object(s) 112 detected by the object detection system 140 where the second time duration is longer for some types of objects 112 than for other types of objects 112. In another example, the second time duration may be based on the first time duration, for instance, a fraction or percentage of the first time duration. In this example, the controller 12 may apply a suitable scaling factor or the like to the first time duration to determine the second time duration. The second time period may be application specific and may vary from embodiment to embodiment.

Specifically, at operation 225, the controller 12 commands the reversible vacuum generator to communicate a positive pressure with respect to atmospheric pressure to the scalper 105 of the multi-directional flow filtration system 100. In some examples, the positive pressure may comprise a positive pressure of an equal but opposite magnitude as the negative pressure initially provided to the scalper. However, in other examples the positive pressure may be of a magnitude greater than the negative pressure (and opposite sign), or in still other examples the positive pressure may be of a magnitude less than the negative pressure (and opposite sign). The positive pressure may be used to eject any materials that have become embedded at least partially within the scalper or otherwise held by the scalper, whereas the negative pressure may be used to provide suction for holding various objects via the scalper until the vacuum is released and/or the positive pressure is supplied.

Proceeding to operation 230, the controller 12 judges whether the second predetermined duration of time has elapsed. If not, then the controller 12 returns to operation 225, where positive pressure is continued to be provided to the scalper(s) 105. Alternatively, responsive to the second predetermined duration being elapsed, the controller 12 proceeds to operation 235 to determine whether there is a system shutoff request. If so, then the controller 12 may trigger or otherwise initiate a system shutdown. The system shutdown may include discontinuing supplying power to the system 100 and/or providing commands to one or more of the reversible vacuum generator 110, the air source 120, the movement system 130, the object detection system 140, and/or other subsystems/components of the system 100. After performance of operation 235 method 200 may end. Alternatively, if a system shutdown is not requested at operation 235, controller 12 returns to operation 205, where the method 200 repeats any number of times. In this way, the multi-directional flow filtration system 100 may repeatedly pick up various selected objects 112 under conditions where vacuum is being supplied to the scalper(s)105, and drop various held objects 112 at a desired location when the vacuum is released and/or responsive to positive pressure being communicated to the scalper(s) 105 of the multi-directional flow filtration system 100. While the operation of indicating whether system shutdown is requested occurs after operation 230 in method 200, it may be understood that the method 200 may end at any time within the sequence of operation, responsive to a request for system shutdown.

While not explicitly illustrated at FIG. 2, in some examples the scalper 105 may include a bypass port that is configured to receive pressurized air (e.g., positive pressure with respect to atmospheric pressure) from the air source 120. Details regarding such a bypass port will be discussed in greater detail infra. Briefly, the bypass port may be independent of a plurality of other chambers (e.g., helical chambers 145) included in the scalper, and as such, may independently receive pressurized air from the air source 120, whereas the plurality of other chambers may receive positive and negative pressure via the reversible vacuum generator 110. The bypass port may be configured to receive a positive pressure via the air source 120 that is of a greater magnitude than the positive pressure communicated to the plurality of other chambers via the reversible vacuum generator. Thus, in some examples as discussed herein, the bypass port may be referred to as a high pressure bypass port.

With regard to the methodology of FIG. 2, in some examples the bypass port may be supplied with positive pressure at operation 225, in addition to, or alternative to, the providing of positive pressure to the plurality of other chambers via the reversible vacuum generator. The positive pressure supplied to the bypass port may accordingly bypass the plurality of other chambers, and may be directed towards an outer opening of the scalper. This high pressurized air may function to draw objects or material out of the plurality of other chambers such that the objects or material may be ejected from the scalper.

In embodiments where the scalper(s)105 includes the bypass port, the bypass port may be supplied with positive pressure via the air source 120 each time that the reversible vacuum generator 110 supplies positive pressure to the plurality of other chambers (e.g., at operation 225 of method 200). In another example, the air source 120 may be commanded to supply the positive pressure to the bypass port responsive to conditions being met for doing so. Such conditions being met may include a threshold number of times that positive pressure has been supplied to the plurality of other chambers elapsing. For example, responsive to the positive pressure being supplied to the plurality of other chambers three times, four times, five times, ten times, twenty times, etc., then positive pressure may additionally or alternatively be supplied to the bypass port via the air source 120 the next time positive pressure is scheduled to be supplied to the plurality of other chambers. In some examples, the positive pressure may be supplied via the air source 120 to the bypass port for one cycle, two cycles, three cycles, five cycles, ten cycles, etc.

In another additional or alternative example, conditions may be met for supplying positive pressure to the bypass port via the air source 120 responsive to an indication of an obstruction in one or more of the plurality of other chambers. For example, an obstruction may comprise (or be caused by) an object or material that is not being readily released responsive to the positive pressure being communicated to the plurality of other chambers via the reversible vacuum generator 110. An obstruction may be indicated, for example, via one or more of a pressure sensors 18 indicating a pressure change greater than a threshold pressure change within the scalper 105, an indication from via the object detection system 140 that there is an apparent obstruction, etc.

In this way, the methodology discussed with regard to FIG. 2 may enable a scalper employed on a multi-directional flow filtration system to passively clean itself of debris simply by regularly reversing air flow through the scalper from a vacuum flow to a positive pressure flow. This cycle of air flow reversal may repeat itself any number of times, and as a result, contaminating debris may be passively ejected from the scalper.

Turning to FIG. 3, depicted is a perspective view 300 and a radial view 330 of an example end effector 305 according to various embodiments. Reference axes 340 are also provided for each view. The end effector 305 may correspond to the end effector 105 of FIG. 1 as discussed above. End effector 305 includes a body 306 having a cylindrical shape in this embodiment. Other body shapes may be used in other embodiments, such as cones, etc. Aside from components included within an interior 307 of end effector 305, it may be understood that end effector 305 is hollow. Line 308 corresponds to a length of scalping section 309.

Scalping section 309 includes a plurality of individual helical chambers 319 (or “helix shaped chambers 319”). It may be understood that the plurality of individual helical chambers may be similar to or the same as helical chamber 145 depicted at FIG. 1. Each of the plurality of helical chambers 319 are formed by scalping section walls 320a, 320b, and 320c (collectively referred to as “scalping section walls 320,” “walls 320,” “helically elongated members 320,” or the like), which are represented by dashed lines in FIG. 3. In embodiments, the walls 320 are arranged in a helixed or helical configuration where each wall 320 extends helically along a length (or portion) of the interior 307 of the body 306 in a helical/helix shape as shown in FIG. 3. Here, “helical” or “helically” means “of, relating to, or having the form of a helix.” A helix is a smooth space curve with tangent lines at a constant angle to a fixed axis, a curve traced on a cylinder or cone by the rotation of a point crossing its right sections at a constant oblique angle, or an object having a spiral or spiral-like form. A helix is defined by a diameter, a pitch (e.g., the height of one complete helix turn, measured parallel to the axis of the helix), direction (e.g., direction of the spiral, winding direction, S-Z twist direction/orientation, right or left handedness, etc.), and number of spirals, twists, or turns. In various embodiments, each of the walls 320 are helixes/helices rotated about a central axis 321, and may have the same or different diameters, pitches, direction, and/or number of turns. In the example of FIG. 3, the walls 320 form a triple helix (or “triplex”) including a set of three congruent geometric helices (e.g., walls 320a, 320b, and 320c) with the same axis (e.g., central axis 321) but differeing by a translation along the axis. The triple helix is also characterized by its pitch, diameter, direction, and number of turns. In this example, each of the walls 320 may have a same, diameter, pitch, direction, and number of turns.

Alternative embodiments may include only a single helix (e.g., formed using one wall 320), a double helix (e.g., formed using only two walls 320), or many more helices than shown (e.g., more than three walls 320). In alternative embodiments, at least one of the walls 320 has a different axis than the other walls 320 regardless of the number of walls 320 included in the end effector 305. In another embodiment, at least one of the walls 320 has a different diameter, pitch, direction, and/or number of turns than the other walls 320 regardless of the number of walls 320 included in the end effector 305.

The helically extended walls 320 separate the interior 307 into multiple helical chambers 319. It may be understood that via the inclusion of helical chambers 319, a surface area corresponding to an inner surface of the end effector may be increased, as compared to a similarly configured end effector lacking the helical chambers. This increase in surface area serves to increase opportunity for objects to come into contact with surfaces (e.g., scalping walls) of the end effector, which in turn improves an ability to scalp such objects from the end effector. Referring to radial view 330, the scalping section walls 320a, 320b, 320c together define hollow helical chambers 319a, 319b, and 319c. A pair of walls 320 and a portion of the interior 307 of the body 306 form a corresponding helical chamber 319. For example, radial view 330 shows helical chamber 319a being formed by a portion of the interior 307 together with walls 320a and 320b; helical chamber 319a being formed by another portion of the interior 307 together with walls 320b and 320c; and helical chamber 319c being formed by yet another portion of the interior 307 together with walls 320a and 320c. Each individual helical chamber 319 may also rotationally wind about the central axis 321.

In some embodiments, individual helical chambers 319 and/or individual walls 320 may make at least one turn around central axis 321 within scalping section 309. In other embodiments, each helical chamber 319 and/or each wall 320 may make at least two turns around central axis 321 within scalping section 309. In some embodiments, each helical chamber 319 and/or each wall 320 may make at least three turns around central axis 321 within scalping section 309.

The various properties/parameters of the helical chambers 319 and/or walls 320 (e.g., wall 320 thickness, length, material(s), twist orientation, chamber 319 size/area/volume, helical diameter, pitch, direction, number of turns, etc.) may be application specific, and may very from embodiment to embodiment. In an example, the dimensions of each helical chamber 319 and/or each wall 320 and number of times in which individual helical chambers 319 and/or individual walls 320 wrap around central axis 321 is a function of desired material(s) to be scalped by scalping section 309. Specifically, the physical features (e.g., pitch, diameter, direction, number of turns about the central axis within the scalping section 309, etc.) forming the individual helical chambers 319 may enable a multi-directional flow filtration system 100 to scalp irregular contamination passively during pressure cycling (e.g., cycling between vacuum and positive pressure as discussed with regard to method 200 at FIG. 2). For purposes of the present disclosure, scalping refers to a process of stopping contaminating material from being communicated through an entirety of an end effector 305, and instead being stopped by the scalping section 309, and then subsequently ejected from the scalping section 309 and end effector 305.

In some embodiments, the end effector 305 may include screen 328 positioned at a first end 329 of scalping section 309 (in other words at a first end of the plurality of helical chambers). The screen 328 may have sieve/screen openings of any suitable size and/or depending on the granularity of materials to be screened or separated. The screen 328 may be a sieve, mesh, or other like device for separating materials. The screen 328 may be formed using a suitable material such as metal, plastic, fiber, and/or other flexible or ductile materials. Screen 328 may be positioned between first end 329 and a vacuum and/or positive pressure source (e.g., reversible vacuum generator 110 at FIG. 1). Second end 331 of scalping section may be proximal to atmosphere, and second end 331 may first encounter objects being introduced to end effector 305 (as opposed to first end 329).

Double-sided arrows 334 are used to illustratively show the direction of air flow into and out of end effector 305 and scalping section 309. Such air flow may be understood to comprise an overall flow capacity through end effector 305. Due to the helical nature of each of the individual helical chambers 319, a blockage or obstruction occurring in one of the helical chambers 319 may not in turn reduce the overall flow capacity, as flow may continue unabated, or may in some examples be increased, in remaining unobstructed chamber(s) 319.

In examples where screen 328 is included, small objects may still be capable of traversing scalping section 309, and may then either pass through or be stopped by screen 328. However, such small objects may be ejected from end effector 305 when the vacuum source is turned off so as to vent the negative pressure to drawing chamber 360 and atmosphere, and/or when flow is reversed so that a positive pressure with respect to atmospheric pressure is introduced to end effector 305, such that the positive pressure encourages the contaminating object to be ejected from scalping section 309 into drawing chamber 360 and then to atmosphere.

Accordingly, the scalping section 309 comprising the plurality of helical chambers 319 enables the scalping of contaminating material without the use of size fractionation screening. Such an ability relies on the physical properties of any contamination that has a large surface area compared to cross-sectional area. Irregular contamination that fits into such a category of large surface area to cross-sectional area ratio may include rigid materials as one example, and malleable materials as another example.

Malleable materials (or malleable contamination) refers to contaminants with topological deformation potential. As a malleable piece of contamination is introduced into end effector 305 by way of drawing chamber 361 under conditions where high vacuum is present in end effector 305, and particularly at vacuum chamber 362, it may be drawn into a single helical chamber 319. The malleable contamination may in some examples be drawn to a single helical chamber 319 due to a particular helical chamber having an elevated vacuum as compared to a lesser vacuum in remaining helical chambers 319. The elevated vacuum may be due to placement of the vacuum source or vacuum port (not shown) with respect to each of the individual helical chambers 319, how screen 328 is constructed, or the like. Malleable material introduced into a helical chamber 319 may elongate under the vacuum pressure. At least three contributing design features corresponding to the scalping section 309 shown at FIG. 3 may prevent the material from either embedding within screen 328 (e.g., in a case where screen 328 is included) or from being introduced to the reversible vacuum source (e.g., reversible vacuum generator 110 at FIG. 1). The three contributing design features/embodiments are each now discussed in turn.

For the first design feature, as the malleable contamination elongates under vacuum, frictional resistance to its continued movement may increase as it is pulled further into a particular helical chamber 319. Such increased resistance to movement may be a function of surface area of walls of the individual helical chamber 319, and the number of turns the individual helical chamber 319 makes around the central axis 321 of the end effector 305. Eytelwein's formula (shown by Equation (1) below) relates a hold force to a load force if a flexible line is wound around a cylinder:

T_{load}=T_{hold}e^{μθ} (1)

In Equation (1), T_{load} is the applied tension on the line, T_{hold} is a resulting force exerted at the other side of the cylinder, μ is a coefficient of friction between the flexible line and the cylinder material(s), and θ is a total angle swept by all turns of the flexible line. Equation (1) may be used to describe how friction resistance may increase as a malleable contaminating material is pulled through an individual helical chamber 319, for example. The increase in friction may be understood to prevent or reduce opportunity for the contaminating malleable material to reach the screen 328 (where included) or to be introduced into other aspects of the multi-directional flow filtration system under situations where screen 328 is not included. In some embodiments, while not explicitly illustrated, chamber wall features such as bumps, grooves, protrusions, etc., may be included as part of the portions of the interior 307 making up the walls of the helical chambers 319 in order to increase holding potential of contaminating material within the scalping section. The chamber wall features may be formed or fabricated from or using the same material the walls 320 and/or the interior 307 of the body 306 (e.g., the walls of individual helical chambers 319), or the features may be formed or fabricated using different materials and attached or fixed to the chamber walls (interior 307). The chamber features may be positioned throughout an entirety of each helical chamber 319, positioned on just a part of each wall of individual helical chambers 319, or may be differentially positioned across different individual helical chambers, etc. The chamber features may be relied upon for increasing a holding tension under vacuum while enabling release of the contaminating material when the vacuum is released and/or the positive pressure is supplied to the plurality of individual helical chambers. Thus, such features may include a directional component to enable improved holding tension under vacuum and reduced holding tension when positive pressure is introduced to the plurality of individual helical chambers.

For the second design feature, due to the helical shape of individual helical chambers 319, dynamic impact between a malleable material and walls of an individual helical chamber 319 may increase holding force of the malleable material against the wall of the individual helical chamber 319. The increased holding force may thereby reduce opportunity for the malleable material to somehow become embedded in the helical chamber 319, embedded in the screen 328, where included), or from being introduced, for example, further into the multi-directional flow filtration system 100. More specifically, due to high air speed within the end effector 305 housing the scalping section 309, as malleable contamination is introduced to a particular individual helical chamber 319, it may crumble or become otherwise compacted, which in turn may increase holding tension of the malleable contamination. In this way, responsive to depressurization and/or responsive to supplying a positive pressure to the end effector, the contaminating material may be readily ejected from the scalping section and end effector.

For the third design feature, in the case where a scalping section 309 of an end effector (305 includes a plurality of individual helical chambers 319, as malleable contamination obstructs flow in one particular individual helical chamber, the vacuum magnitude in that particular chamber may be reduced responsive to vacuum flow stabilization of other non-obstructed individual helical chambers. Because vacuum flow is allowed to stabilize via the other non-obstructed chambers, this may prevent development of a high vacuum in the area of the vacuum chamber 362. The avoidance of an increased vacuum magnitude at the vacuum chamber of the end effector in response to an obstruction in one or more (but less than all) individual helical chambers may result in the malleable contamination not becoming tightly wedged within the individual helical chamber, which may enable the contaminating material to be readily ejected upon end effector depressurization and/or responsive to introduction of a positive pressure to the end effector.

With regard to the operation of reversing flow within the end effector and scalping section 309 from a vacuum (e.g., negative pressure with respect to atmospheric pressure) to a positive pressure (e.g., positive with respect to atmospheric pressure), the following principles may apply with regard to the scalping sections of the present disclosure. First, upon switching from providing the vacuum to providing the positive pressure, an impact force of the positive pressure may encourage the contaminating material at least partially obstructing a particular individual helical chamber to become ejected from the scalping section and end effector. Second, as the flow is inverted from a vacuum to a positive pressure, malleable contamination may be drawn from its position within an individual helical chamber due to the formation of a low pressure system at the drawing chamber 360 of the end effector 305. Third, as contamination is pulled from the system, the holding friction due to the helical surface of each individual helical chamber 319 may diminish as a function of distance, thereby further encouraging the ejection of contaminating material from the particular individual helical chamber 319. Finally, any exposed contamination in the drawing chamber 360 or just outside of the exit port 370 of the end effector 305 may be subjected to a parasitic drag as a function of air speed in the drawing chamber. Oversized malleable contamination such as film, textiles or string may be especially susceptible to skin friction as any exposed surface interacts the high air speed.

Another example of irregular contamination that fits into the category defined by a large ratio of surface area to cross-sectional area may comprise rigid materials (e.g., pencil, pen, battery, etc.). Scalping and removing rigid contaminating materials may be a function of the geometrical properties of the individual helical chambers 319, which enable the scalping sections 309 of the present disclosure to prevent objects 112 having a smaller cross-sectional area than an aperture opening to an individual helical chamber 319 from traversing an entirety of the scalping section 309. Specifically, a rigid object 112 with a convex area less than the aperture opening of a particular individual helical chamber 319 may attempt to traverse through an entirety of a particular helical chamber 319, but may be prevented by the helix pitch by the convex to length ratio. Even under circumstances where such an object 112 may be capable of passing through the screen 328, where included, the object 112 may not reach the screen 328 due to an inability to traverse the length of the helical chamber 319. The rigid object may become immobilized within the helical chamber 319 while the vacuum is supplied to the end effector 305, and then once the flow is reversed the rigid object may be ejected from the scalping section 309 and end effector 305 from the combined efforts of parasitic drag within the drawing chamber 360 of the end effector 305, pull force due to a pressure difference within the drawing chamber, and any impact force produced within an individual helical chamber (319 where the contaminating rigid material resides.

Turning now to FIG. 4, which depicts another example embodiment 400 of an end effector 405. While some components of end effector 405 are similar to components of the end effector discussed at FIG. 3, for clarity different numerals are used between the end effector of FIG. 3 and the end effector of FIG. 4.

End effector 405 includes body 406. End effector 405 includes scalping section 409. Similar to the scalping section 309 discussed with regard to FIG. 3, scalping section 409 includes a plurality of helical chambers 419. Further included is drawing chamber 460 and air chamber 462. End effector 405 further includes bypass port 480. While each helical chamber 419 of the plurality of helical chambers 419 receives vacuum or positive pressure from the reversible vacuum generator 110 by way of air chamber 462, bypass port 480 may receive high pressure air (e.g., positive pressure in the direction of arrow 481) from the air source 120. Bypass port 480 may run parallel to, and in some examples, may surround central axis 421 of end effector 405. While the depicted illustration at FIG. 4 is a cross-section of end effector 405, the plurality of individual helical chambers 419 may at least partially surround bypass port 480. For example, each of the plurality of individual helical chambers 419 may make one or more turns around bypass port 480 within scalping section 409. Bypass port 480 may bypass each of the plurality of individual helical chambers 419, and may further bypass air chamber 462.

The bypass port 480 may receive high pressure air from the air source 120 in the direction of arrow 481, and this may create a high flow rate within drawing chamber 460. The high flow rate may maximize air speed within drawing chamber 460, thereby exponentially increasing parasitic drag force acting on any contamination within a particular helical chamber of the scalping section. Furthermore, the high flow rate at drawing chamber 460 may produce a low pressure system at air chamber 462, and may still further apply a direct impact force acting on any contaminate at least partially exposed from one or more of the individual helical chambers 419 (e.g., contaminate at least partially exposed to drawing chamber 460 at FIG. 4).

In some cases, it may not be desirable to supply high pressure air to bypass port 480 under conditions where vacuum is being provided to the plurality of helical chambers 419 by way of air chamber 462. Instead, in some embodiments it may be desirable to supply high pressure air to bypass port 480 under conditions where positive pressure is also being supplied to the plurality of helical chambers by way of air passage 462. In this way, the action of high pressure air supplied by way of bypass port 480 may assist the positive pressure supplied to the plurality of individual helical chambers 419, to encourage contaminating material to be ejected from scalping section 409, and drawing chamber 460. In some examples, control strategy may provide the high pressure air by way of bypass port 480 each time that the flow to individual helical chambers via the first reversible vacuum source reverses to provide positive pressure to the individual helical chambers. In such an example, the high pressure air may be supplied for an entire time that the plurality of individual helical chambers is receiving positive air pressure from the first reversible vacuum source, or a fraction of the time that the individual helical chambers receive the positive pressure from the first reversible vacuum source.

In other additional or alternative embodiments, high pressure air may be supplied to bypass port 480 when predetermined conditions are met. As one example, the high pressure air may be supplied after a predetermined number of times that air flow to the plurality of individual helical chambers has reversed. For example, after flow to the individual helical chambers has reversed a threshold number of times (e.g., five times), then on the subsequent flow reversal where positive pressure is supplied to the plurality of individual helical chambers, high pressure air flow may additionally be provided to bypass port 480 for an entirety or a fraction of the time that the positive pressure is supplied to the plurality of individual helical chambers. As another example, predetermined conditions being met may include some indication of an obstruction within scalping section 409. As an example, of such an indication, one or more pressure sensors 18 may be included within one or more individual helical chambers 419, within air chamber 462, and/or within drawing chamber 460. A pressure as monitored via the one or more pressure sensors 18 that differs from an expected pressure by more than a threshold may comprise an indication that one or more of the plurality of individual helical chambers 419 or some aspect of drawing chamber 460 (or air chamber 462) is obstructed to at least some extent. Responsive to such an indication, the controller 12 may control the air source 120 to provide high pressure air to bypass port 480 to further encourage the ejection of the contaminating material from the end effector 405. Additionally or alternatively, such an indication may be provided by way of the object detection system 140. For example, the object detection system 140 may include one or more image sensors 18 that are configured to capture images, and the controller 12 or some other detection mechanism of the object detection system 140 may use the image data to infer whether mitigating action may be desirable in the form of the providing of high pressure air to the bypass port 480, to encourage a particular contaminating material to be ejected from the end effector 405.

Turning now to FIG. 5, depicted is another example embodiment 500 of an end effector 505 of the present disclosure. While some components of end effector 505 are similar to components of the end effectors discussed at FIG. 3 and FIG. 4, for clarity different numerals are used between the end effector of FIGS. 3-4 and the end effector 505 of FIG. 5.

End effector 505 does not include a bypass port (e.g., bypass port 480 at FIG. 4). End effector 505 includes body 506, scalping section 509, drawing chamber 560, and air or vacuum chamber 562. Scalping section 509, similar to the scalping section 309 discussed with regard to FIG. 3 includes a plurality of helical chambers 519 leading from drawing chamber 560 to air chamber 562. The end effector of FIG. 5 may be used with an open-loop reversing flow system utilizing a same flow track for vacuum (e.g., negative pressure with respect to atmospheric pressure) and exhaust flow (e.g., zero flow or positive pressure with respect to atmospheric pressure). The same flow track in this example comprises the plurality of individual helical chambers 519 which comprise scalping section 509. Furthermore, the vacuum and exhaust flow in this example is each provided via the reversible vacuum generator 110.

In this example, one of the plurality of individual helical chambers 519 is obstructed. Specifically, the end effector 505 includes obstructed helical chamber 514. In this example, exhaust flow (positive pressure) in the direction of arrow 581 enters the end effector 505 by way of vacuum chamber 562, and from there follows a pathway of least resistance through scalping section 509 via unobstructed helical chambers 519, and then out drawing chamber 560. Thus, when one helical chamber is obstructed, the air flow may travel through unobstructed helical chambers 519, and may result in a high flow rate of air at drawing chamber 560. The high flow rate at drawing chamber 560 may in turn produce a low pressure system in obstructed helical chamber 514 thereby drawing contaminants from the system as well as providing a direct impact force at the obstructing material. Once the contaminating material is exposed to drawing chamber 560, the contaminant may be pulled by parasitic drag and ejected from end effector 505.

Turning now to FIG. 6, which depicts another example embodiment 600 of an end effector 605 of the present disclosure. While the components of end effector 605 are similar to components of the end effectors discussed at FIGS. 3-5, for clarity different numerals are used between the end effector of FIGS. 3-5 and the end effector 605 of FIG. 6.

End effector 605 includes a body 606 and a plurality of scalping sections 608. Specifically, in this example embodiment 600, end effector 605 includes a first scalping section 609 and a second scalping section 610. However, while just two scalping sections are illustrated by FIG. 6, it should be understood that more than two scalping sections (e.g., 3, 4, 5, or 6) may be included in other embodiments without departing from the scope of this disclosure.

Each of first scalping section 609 and second scalping section 610 may be substantially similar or the same as scalping section 309 discussed in detail with regard to FIG. 3. First scalping section 609 may include a first plurality of helical chambers 619a, and second scalping section 610 may include a second plurality of helical chambers 619b. The first plurality of helical chambers 619a are formed by scalping section walls 620a, 620b and 620c, collectively referred to as “scalping section walls 620”, “walls 620,” “helically elongated members 620,” or the like. Similarly, the second plurality of helical chambers 619b are formed by scalping section walls 621a, 621b and 621c, collectively referred to as “scalping section walls 621”, “walls 621,” “helically elongated members 621,” or the like.

In some embodiments, the first scalping section 609 may have a same or similar arrangement as the first scalping section 610. For example, a number of scalping section walls, and, in turn, a number of helical chambers included in the first scalping section 609 and the second scalping section 610 may be the same or similar to one another. Alternatively, the number of scalping section walls, and, in turn, a number of helical chambers of the first scalping section 609 may be different than the number of scalping section walls (and helical chambers) of the second scalping section 610. Various other aspects of the scalping section walls and helical chambers of the first scalping section 609 may be the same or similar, or different than the various other aspects of the scalping section walls and helical chambers of the second scalping section 610.

In various embodiments, each of the walls 620 are helixes/helices rotated about central axis 622, and each of the walls 621 are helixes/helices rotated about central axis 623. Other aspects of each of walls 620 and/or walls 621 including but not limited to diameter, pitch, direction, number of turns, number of helices, etc., have been discussed in detail previously and equally apply to walls 620 and/or walls 621 discussed with regard to FIG. 6. For example, the various properties/parameters of the helical chambers 619a and/or 619b (e.g., size/area/volume, helical diameter, pitch, direction, number of turns, etc.) and/or the various properties/parameters of the helical walls 620 and/or 621 (e.g., wall thickness, wall length, material(s), twist orientation, etc.) may be application specific and may vary from embodiment to embodiment.

Each of first scalping section 609 and second scalping section 610 are at least partially surrounded by body 606. Said another way, body 606 is continuous around at least a portion of each of first scalping section 609 and second scalping section 610. Dashed lines 630 are used to indicate where first scalping section 609 and second scalping section 610 penetrate body 606 and are communicably coupled to inner cavity 632 by way of the interiors of each of first scalping section 609 and second scalping section 610.

Shown for reference at FIG. 6 is reference axes 340. Each of first scalping section 609 and second scalping section 610 extend away from inner cavity 632 along one or more of the x-y plane and the y-z plane. For example, each of first scalping section 609 and second scalping section 610 may angularly extend away from inner cavity 632. The angle of the first scalping section 609 with respect to the inner cavity 632 may be the same or similar as the angle of the second scalping section 610 with respect to the inner cavity 632, or such angles may be different from one another. The particular angles of the first scalping section 609 and/or the second scalping section 610 with respect to the inner cavity 632 may be implementation specific and may vary from embodiment to embodiment.

For reference, perspective view 640 illustrates one possible orientation of end effector 605 with regard to first scalping section 609 and section scalping section 610. Perspective view 640 illustrates an external view of end effector 605, where first scalping section 609 angularly extends outwardly with respect to a plane of the page, and where second scalping section 610 angularly extends inwardly with respect to the plane of the page. Rotation of the end effector 605 about central axis 652 may be understood to cause first scalping section 609 to angularly extend inwardly with respect to the plane of the page and may cause second scalping section 610 to angularly extend outwardly with respect to the plane of the page. Perspective view 640 is thus presented to illustrate a three-dimensional example view of end effector 605, for reference. However, it should be understood that such an example as shown by perspective view 640 is meant to be illustrative, and other orientations of the scalping sections are within the scope of this disclosure. For example, as shown at perspective view 640, each of first scalping section 609 and second scalping section 610 are substantially aligned along the x-axis. However, other orientations are within the scope of this disclosure. For example, first scalping section 609 may be positioned closer to upper portion 641 and farther away from lower portion 642 of end effector 605, and second scalping section 610 may be positioned closer to lower portion 642 and farther from upper portion 641 of end effector 605, or vice versa. Furthermore, there may be any number of scalping sections positioned circumferentially around end effector 605, each of which may be positioned in any location with respect to the x-axis of end effector 605, depending on the application.

First bidirectional arrow 645 is used to indicate that first scalping section 609 may receive vacuum or positive pressure from a reversible vacuum generator (e.g., first reversible vacuum generator 110 at FIG. 1). Similarly, second bidirectional arrow 647 is used to indicate that second scalping section 610 may receive vacuum or positive pressure from a reversible vacuum generator (e.g., first reversible vacuum generator 110 at FIG. 1). In some examples, first scalping section 609 and second scalping section 610 may receive vacuum or positive pressure from the same reversible vacuum generator, however in other examples different reversible vacuum generators may be used for providing the vacuum or positive pressure to each of first scalping section 609 and second scalping section 610. While not explicitly illustrated, it may be understood that each of first scalping section 609 and second scalping section 610 may be communicably coupled to their respective reversible vacuum generator(s) by way of a hose, tubing, pipe, etc. The hose, tubing, pipe, etc., may fit around an outer circumference of each of first scalping section 609 and second scalping section 610, and may be secured by way of a clamp (e.g., screw/band clamp, spring clamp, wire clamp, ear clamp, ring clamp, etc.), non-permanent adhesive (e.g., tape, putty, etc.), etc.

End effector 605 may include bypass port 655. Bypass port 655 may be communicably coupled to inner cavity 632 of end effector 605, which in turn may be communicably coupled to drawing chamber 660. Similar to that discussed with regard to FIG. 4, while each of first scalping section 609 and second scalping section 610 receive vacuum or positive pressure from a reversible vacuum generator, bypass port 655 may receive high pressure air (e.g., positive pressure in the direction of arrow 650) from another air source (e.g., an air source the same or similar to air source 120 at FIG. 1). Bypass port 655 may run parallel to, and may surround, central axis 652 of end effector 605. Similarly, inner cavity 632 and drawing chamber 660 may each run substantially parallel to, and may surround, central axis 652 of end effector 605.

During operation, inner cavity 632 and drawing chamber 660 may receive vacuum or positive pressure by way of first scalping section 609 and/or second scalping section 610. Under some operating conditions, bypass port 655 may receive high pressure air in the direction of arrow 650, which may be in turn communicated to inner cavity 632 and drawing chamber 660. The high flow rate may maximize air speed within inner cavity 632 and drawing chamber 660, thereby exponentially increasing parasitic drag force acting on any contamination within a particular scalping section (e.g., first scalping section 609 and/or second scalping section 610). Furthermore, the high flow rate within inner cavity 632 and drawing chamber 660 may apply a direct impact force acting on any contaminate at least partially exposed from one or more of the scalping sections 608 (e.g., contaminate at least partially exposed to inner cavity 632 and/or drawing chamber 660). Accordingly, third bidirectional arrow 665 is used to indicate that inner cavity 632 and drawing chamber 660 may receive positive pressure or vacuum. The positive pressure may be supplied by way of scalping sections 608 via the one or more reversible vacuum generators (e.g., first reversible vacuum generator 110 at FIG. 1), and/or by way of bypass port 655 via another air source (e.g., air source the same or similar to air source 120 at FIG. 1). The vacuum may be supplied by way of scalping sections 608 via the one or more reversible vacuum generators.

Thus, the end effector 605 depicted at FIG. 6 may operate by activating vacuum flow to inner cavity 632 and drawing chamber 660 by way of scalping sections 608 for a first predetermined duration, and then the vacuum may be released and the flow may reversed such that, by way of scalping sections 608, positive pressure is communicated to each of inner cavity 632 and drawing chamber 660 for a second predetermined duration. Such a cycle may repeat any number of times. In this way, end effector 605 may, via scalping sections 608, trap various objects while vacuum is being communicated to inner cavity 632 and drawing chamber 660, and may then passively eject those various objects when the positive pressure is applied by way of scalping sections 608 (and in some examples by way of bypass port 655).

Similar to that discussed with regard to FIG. 4 above, it may not be desirable to supply high pressure air to bypass port 655 under conditions where vacuum is being provided to inner cavity 632 and drawing chamber 660 by way of scalping sections 608. Instead, in some embodiments it may be desirable to supply high pressure air to bypass port 655 under conditions where positive pressure is also being supplied to inner cavity 632 and drawing chamber 660 by way of scalping sections 608. In this way, the action of high pressure air supplied by way of bypass port 655 may assist the positive pressure supplied to scalping sections 608, to encourage contaminating material to be ejected from one or more of first scalping section 609, second scalping section 610, inner cavity 632 and drawing chamber 660. In some examples, control strategy may provide the high pressure air by way of bypass port 655 each time that the flow to scalping sections 608 reverses to provide positive pressure to the inner cavity 632 and drawing chamber 660. In such an example, the high pressure air may be supplied for an entire time that scalping sections 608 are receiving positive air pressure from the reversible vacuum generator(s), or a fraction of the time that scalping sections 608 receive the positive pressure from the reversible vacuum generator(s).

In other additional or alternative embodiments, high pressure air may be supplied to bypass port 655 when predetermined conditions are met. As one example, the high pressure air may be supplied after a predetermined number of times that air flow to the inner cavity 632 and drawing chamber 660 by way of scalping sections 608 has reversed. For example, after flow has reversed a threshold number of times (e.g., three times, five times, 10 times, etc.), then on the subsequent flow reversal where positive pressure is supplied to the inner cavity 632 and drawing chamber 660 by way of scalping sections 608, high pressure air flow may additionally be provided to bypass port 655 for an entirety or a fraction of the time that the positive pressure is supplied to the inner cavity 632 and drawing chamber 660 by way of scalping sections 608. As another example, predetermined conditions being met may include some indication of an obstruction within one or more of first scalping section 609, second scalping section 610, inner cavity 632 and drawing chamber 660. As an example, of such an indication, one or more pressure sensors 18 (not shown at FIG. 6) may be included within one or more of first scalping section 609, second scalping section 610, inner cavity 632 and drawing chamber 660. A pressure as monitored via the one or more pressure sensors that differs from an expected pressure by more than a threshold may comprise an indication that one or more of first scalping section 609, second scalping section 610, inner cavity 632 and drawing chamber 660 is obstructed to at least some extent. Responsive to such an indication, the controller (e.g., controller 12 at FIG. 1) may control the air source (e.g., air source 120 at FIG. 1) to provide high pressure air to bypass port 655 to further encourage the ejection of the contaminating material from the end effector 605. Additionally or alternatively, such an indication may be provided by way of the object detection system (e.g., object detection system 140 at FIG. 1). For example, the object detection system may include one or more image sensors (e.g., sensors 18 at FIG. 1) that are configured to capture images, and the controller or some other detection mechanism of the object detection system may use the image data to infer whether mitigating action may be desirable in the form of the providing of high pressure air to the bypass port 655, to encourage a particular contaminating material to be ejected from the end effector 605.

In this way, scalping sections of the end effectors of the present disclosure, which each include a plurality of individual helical chambers, may enable multi-directional flow filtration systems such as those discussed herein to passively eject irregular contamination without reduction in overall flow the system can produce under situations where less than a maximum number of the plurality of helical chambers is obstructed by contaminating material. This may in turn improve operation of the multi-directional flow filtration system, enabling operation to continue whereas operation may otherwise have to be aborted for some amount of time to address situations of reduced vacuum flow. Furthermore, the helical nature of the individual chambers may reduce opportunity for contaminating material, particularly malleable material including but not limited to film, string, etc., to embed within a screen, filter, or other aspect of an end effector or other components of a multi-directional flow filtration system. This may additionally improve operation of the multi-directional flow filtration system, as the passive ability of the end effectors of the present disclosure to remove irregular contaminating material may dramatically reduce time otherwise spent addressing issues related to clogged or otherwise obstructed end effectors of similar multi-directional flow filtration systems. The reduction in potential adverse conditions associated with operation of the multi-directional flow filtration systems of the present disclosure may improve lifetime of a number of components of the multi-directional flow filtration systems of the present disclosure, and may reduce costs associated with one or more of system downtime, technician fees, replacement parts, etc. In turn, other operational aspects of the systems of the present disclosure may be improved, such as time to conduct particular tasks, worker satisfaction, etc.

In any of the aforementioned embodiments, the multi-directional flow filtration systems and/or the components/elements thereof may be manufactured or formed using any suitable fabrication means. Additionally or alternatively, the multi-directional flow filtration systems and/or the components/elements thereof may be formed or fabricated using any suitable material or combination of materials.

Some non-limiting examples are provided infra. The following examples pertain to further embodiments. Specifics in the examples may be used anywhere in one or more embodiments discussed previously.

A first example includes an apparatus for reducing contamination or obstruction of a multi-directional flow filtration system comprising a body of a scalper of the multi-directional flow filtration system, and a plurality of helical chambers extending longitudinally along at least a portion of an interior of the body of the scalper and rotationally around a central axis of the interior of the body of the scalper.

A second example includes the first example and/or some other examples herein, wherein the plurality of helical chambers comprise a scalping section of the scalper.

A third example includes the second example and/or some other examples herein, wherein the scalping section may include at least two helical chambers, in one embodiment.

A fourth example includes the second or third examples and/or some other examples herein, wherein the scalping section may include three helical chambers.

A fifth example includes any of the aforementioned examples and/or some other examples herein, wherein the plurality of helical chambers are fixed with respect to the body of the scalper and one another, where each of the plurality of helical chambers does not move or remains fixed during operation of the multi-directional flow filtration system.

A sixth example includes any of the aforementioned examples and/or some other examples herein, wherein each of the plurality of helical chambers are configured for communicating a vacuum from a first vacuum generator of the multi-directional flow filtration system, to an exterior of the scalper.

A seventh example includes any of the aforementioned examples and/or some other examples herein, wherein the plurality of helical chambers cross-sectionally extend from the central axis of the interior body of the scalper to an inner wall of the body of the scalper.

An eighth example includes any of the aforementioned examples and/or some other examples herein, wherein the plurality of helical chambers occupy an entirety of an inner diameter of the scalper, at least for a portion of the length of the scalper.

A ninth example includes any of the aforementioned examples and/or some other examples herein, wherein the apparatus further comprises a hollow high pressure bypass port configured to receive vacuum or pressurized air therethrough from a second vacuum generator or a compressor, respectively, of the multi-directional flow filtration system.

A tenth example includes the ninth example and/or some other examples herein, wherein the high pressure bypass port is positioned parallel to the central axis.

An eleventh example includes the ninth or tenth example and/or some other examples herein, wherein the high pressure bypass port is at least partially surrounded by the plurality of helical chambers.

A twelfth example includes any of the aforementioned examples and/or some other examples herein, wherein the apparatus further comprises a perforated screen positioned proximal to a first end of the plurality of helical chambers, wherein the first end of the plurality of helical chambers is distal to a second end of the plurality of helical chambers, and wherein the second end is proximal to atmosphere.

A thirteenth example includes the twelfth example and/or some other examples herein, wherein the perforated screen is perpendicular to the central axis of the interior of the body of the end effector.

A fourteenth example includes the twelfth example and the thirteenth example and/or some other examples herein, wherein the perforated screen is positioned between the first end of the plurality of helical chambers and the first vacuum generator.

A fifteenth example includes the fourteenth example and/or some other examples herein, wherein the first end of the plurality of helical chambers is positioned between the perforated screen and the second end of the plurality of helical chambers.

A sixteenth example includes a multi-directional flow filtration system that comprises a reversible vacuum generator, and a suction cup (also referred to herein as an end effector or scalper) having an external body that surrounds a plurality of helical chambers which extend longitudinally along a length of the suction cup and rotationally about a central axis of the suction cup. The system further comprises a controller. The controller stores instructions in non-transitory memory that, when executed, causes the controller to command a sequence of operation that includes commanding the reversible vacuum to communicate a first negative pressure with respect to atmospheric pressure to the plurality of helical chambers for a first duration. The instructions further include commanding the reversible vacuum generator to communicate a first positive pressure to the plurality of helical chambers with respect to atmospheric pressure for a second duration subsequent to the first duration elapsing. The sequence of operation is repeated any number of times.

A seventeenth example includes the sixteenth example and/or some other examples herein, wherein the plurality of helical chambers each have same dimensions.

An eighteenth example includes any of the aforementioned examples of the multi-directional flow filtration system and/or some other examples herein, wherein each of the plurality of helical chambers make at least one turn about the central axis.

A nineteenth example includes any of the aforementioned examples of the multi-directional flow filtration system and/or some other examples herein, wherein the system further comprises a bypass port that extends longitudinally along the length of the suction cup and parallel to the central axis of the suction cup.

A twentieth example includes the nineteenth example and/or some other examples herein, wherein the bypass port is included (at least in part) within an interior of the suction cup, and is at least partially surrounded by the plurality of helical chambers.

A twenty-first example includes the twentieth example and/or some other examples herein, wherein the system further comprises a pressurized air source different from the reversible vacuum generator.

A twenty-second example includes the twenty-first example and/or some other examples herein, wherein the controller stores further instructions to supply pressurized air to the bypass port via the pressurized air source while the reversible vacuum generator is communicating the first positive pressure to the plurality of helical chambers, responsive to one or more predetermined conditions being met for supplying pressurized air to the bypass port.

A twenty-third example includes the twenty-second example and/or some other examples herein, wherein the one or more predetermined conditions include an indication that one or more of the plurality of helical chambers is at least partially obstructed.

A twenty-fourth example includes an apparatus for a multi-directional flow filtration system.

A twenty-fifth example includes the twenty-fourth example and/or some other examples herein, wherein the apparatus includes an scalper having a body that surrounds a scalping section. The scalping section includes a first helical chamber, a second helical chamber, and a third helical chamber. Each of the first helical chamber, the second helical chamber, and the third helical chamber extend longitudinally along a length of the body of the scalper and rotationally about a central axis of an interior of the body of the scalper. Furthermore, each of the first helical chamber, the second helical chamber and the third helical chamber are configured to receive a vacuum or a positive pressure via a reversible vacuum generator of the multi-directional flow filtration system. The first helical chamber receives a greater magnitude vacuum and/or a greater magnitude positive pressure than either of the second helical chamber and the third helical chamber in an absence of obstruction of each of the first helical chamber, the second helical chamber, and the third helical chamber.

A twenty-sixth example includes the twenty-fifth example of the apparatus and/or some other examples herein, wherein the first helical chamber receives the greater magnitude vacuum and/or greater magnitude positive pressure due to a positioning of the first helical chamber in relation to the reversible vacuum generator, or in relation to a port that fluidically couples the reversible vacuum generator to the scalper.

A twenty-seventh example includes any of the aforementioned examples of the apparatus and/or some other examples herein, wherein the apparatus further comprises an absence of a size fractioning screen otherwise additional to the scalping section.

A twenty-eighth example includes any of the aforementioned examples of the apparatus and/or some other examples herein, wherein the scalping section is configured to trap a material having a cross-sectional area less than another cross-sectional area defining an opening aperture corresponding to each of the first helical chamber, the second helical chamber, and the third helical chamber, where the material has a surface area greater than a predetermined threshold surface area.

A twenty-ninth example includes a scalper to be employed on a multi-directional flow filtration system, the scalper comprising a body, and a set of scalping walls forming a plurality of helical chambers, the set of scalping walls helically extending along at least a portion of an interior of the body in a longitudinal direction.

A thirtieth example includes the twenty-ninth example and/or some other examples herein, wherein the set of scalping walls form at least two individual helical chambers.

A thirty-first example includes any of the aforementioned examples of the scalper and/or some other examples herein, wherein the set of scalping walls form three individual helical chambers.

A thirty-second example includes any of the aforementioned examples of the scalper and/or some other examples herein, wherein each scalping wall of the set of scalping walls is fixed within a scalping section of the scalper.

A thirty-third example includes any of the aforementioned examples of the scalper and/or some other examples herein, wherein each helical chamber of the plurality of helical chambers is configured to provide a vacuum force from a first vacuum generator of the multi-directional flow filtration system to an exterior of the scalper.

A thirty-fourth example includes any of the aforementioned examples of the scalper and/or some other examples herein, wherein the plurality of helical chambers occupy an entirety of an inner diameter of the scalper, along at least the portion of the interior of the body.

A thirty-fifth example includes any of the aforementioned examples of the scalper and/or some other examples herein, further comprising a hollow high pressure bypass port configured to receive vacuum or pressurized air provided by a second vacuum generator of the multi-directional flow filtration system.

A thirty-sixth example includes the thirty-fifth example and/or some other examples herein, wherein the hollow high pressure bypass port is at least partially surrounded by the plurality of helical chambers.

A thirty-seventh example includes any of the aforementioned examples of the scalper and/or some other examples herein, further comprising a perforated screen positioned proximal to a first end of the plurality of helical chambers, wherein the first end of the plurality of helical chambers is distal to a second end of the plurality of helical chambers, and the second end is proximal to an opening of the end-effector.

A thirty-eighth example includes a multi-directional flow filtration system, comprising a reversible vacuum generator, and a suction mechanism having an external body that surrounds one or more helically elongated members, the one or more helically elongated members forming a plurality of helical chambers that extend helically along a length of the suction mechanism in a longitudinal direction. The multi-directional flow filtration system further comprises a controller configurable to control the reversible vacuum generator to communicate a first negative pressure with respect to atmospheric pressure to the plurality of helical chambers for a first duration, and control the reversible vacuum generator to communicate a first positive pressure to the plurality of helical chambers with respect to atmospheric pressure for a second duration subsequent to the first duration elapsing.

A thirty-ninth example includes the thirty-eighth example and/or some other examples herein, wherein the one or more helically elongated members further comprise a set of walls that at least in part form the plurality of helical chambers.

A fortieth example includes any of the aforementioned examples of the multi-directional flow filtration system and/or some other examples herein, further comprising a bypass port that extends longitudinally along the length of the suction mechanism and within an interior of the external body.

A forty-first example includes the fortieth example and/or some other examples herein, wherein the bypass port is at least partially surrounded by the one or more helically elongated members.

A forty-second example includes the forty-first example and/or some other examples herein, further comprising a pressurized air source. The controller stores further instructions to supply pressurized air to the bypass port while the reversible vacuum generator is communicating the first positive pressure to the plurality of helical chambers, responsive to one or more predetermined conditions being met for supplying pressurized air to the bypass port.

A forty-third example includes the forty-second example and/or some other examples herein, wherein the one or more predetermined conditions include an indication that the suction mechanism is at least partially obstructed.

A forty-fourth example includes an apparatus for a vacuum-driven pick and place system, comprising an end-effector having a body that surrounds a scalping section, the scalping section including a set of scalping walls that at least in part form a first helical chamber, a second helical chamber, and a third helical chamber, the set of scalping walls extending helically along at least a portion of an interior of the body in a longitudinal direction. Each of the first helical chamber, the second helical chamber and the third helical chamber is configured to receive a vacuum or a positive pressure via a reversible vacuum generator of the vacuum-driven pick and place system.

A forty-fifth example includes the forty-fourth example and/or some other examples herein, wherein the first helical chamber is configured to receive a greater magnitude vacuum and/or a greater magnitude positive pressure via the reversible vacuum generator of the vacuum-driven pick and place system in an absence of obstruction of the scalping section.

A forth-sixth example includes any of the aforementioned examples of the apparatus for the vacuum-driven pick and place system and/or some other examples herein, further comprising a bypass port extending longitudinally along at least the portion of the interior of the body, the bypass port configured to receive pressurized air via an air source of the vacuum-driven pick and place system. The bypass port does not receive the vacuum or the positive pressure via the reversible vacuum generator.

A forty-seventh example includes the forty-sixth example and/or some other examples herein, wherein the bypass port is at least partially surrounded by the set of walls that at least in part form the first helical chamber, the second helical chamber, and the third helical chamber.

A forty-eighth example includes a method of passively screening and ejecting a contaminating material from a scalper employed in an open-loop multi-directional flow filtration system. The method comprises applying a negative pressure via a reversible vacuum generator to an interior of the scalper, the interior of the scalper including a drawing chamber proximal to atmosphere and a scalping section positioned between the drawing chamber and the reversible vacuum generator, wherein the scalping section includes a plurality of scalping walls which together form a plurality of helical chambers, each of the plurality of helical chambers having an open aperture cross-sectional area. The method further comprises, after a first predetermined duration, stopping application of the negative pressure, and applying, after stopping the application of the negative pressure, a positive pressure via the reversible vacuum generator to the interior of the scalper for a second predetermined duration. For the method, the negative pressure traps the contaminating material within a single helical chamber of the plurality of helical chambers, and the positive pressure contributes to dislodging the contaminating material from the single helical chamber and ejecting the contaminating material from the scalper to atmosphere.

A forty-ninth example optionally includes the forty-eighth example, and further comprises applying the negative pressure for the first predetermined duration and then applying the positive pressure for the second predetermined duration in a cycle that repeats any number of times.

A fiftieth example of the method optionally includes any of the aforementioned examples and/or some other examples herein, and further includes wherein the negative pressure traps the contaminating material within the single helical chamber under conditions where the contaminating material is of a cross-sectional area that is less than the open aperture cross-sectional area of any one of the plurality of helical chambers.

A fifty-first example of the method optionally includes the fiftieth example and/or some other examples herein, and further includes wherein the contaminating material comprises a rigid, non-malleable material. In such an example, the method further includes wherein trapping the rigid, non-malleable material is a function of one or more of a helix pitch of the single helical chamber and a convex-to-length ratio of the rigid, non-malleable material, and a collision force between the rigid, non-malleable material and a scalping wall of the single helical chamber.

A fifty-second example of the method optionally includes the fiftieth example and/or some other examples herein, and further includes wherein the contaminating material comprises a malleable material. In such an example, the method further includes wherein trapping the malleable material is a function of one or more of a friction resistance between the malleable material and a scalping wall of the single helical chamber that increases as the malleable material elongates within the single helical chamber, and a dynamic impact between the malleable material and the scalping wall.

A fifty-third example of the method optionally includes any of the aforementioned examples and/or some other examples herein, and further includes wherein trapping the contaminating material within the scalping section prevents the contaminating material from reaching and clogging a screen positioned within the interior of the scalper between the scalping section and the reversible vacuum generator, or, in an absence of the screen, from being drawn into the open-loop multi-directional flow filtration system upstream of the scalper.

A fifty-fourth example of the method optionally includes any of the aforementioned examples, and further includes wherein inverting flow through the interior of the scalper via stopping applying the negative pressure and then applying the positive pressure produces a pull force on the scalping section as a result of an induced pressure difference in the drawing chamber, the pull force on the scalping section serving to encourage the contaminating material to be dislodged from the single helical chamber and then ejected from the scalper.

A fifty-fifth example of the method optionally includes any of the aforementioned examples, and further comprises supplying a positive pressurized air flow from an air source to the drawing chamber by way of a bypass port that bypasses the scalping section, the positive pressurized air flow causing an increase in the pull force on the scalping section that in turn serves to further encourage the contaminating material to be dislodged from the single helical chamber and then ejected from the scalper.

A fifty-sixth example of the method optionally includes any of the aforementioned examples, and further includes wherein applying the positive pressure via the reversible vacuum generator produces an impact force on the contaminating material that encourages the contaminating material to dislodge from the single helical chamber and be ejected from the scalper.

A fifty-seventh example of the method optionally includes any of the aforementioned examples, and further includes wherein trapping the contaminating material within the single helical chamber during the applying of the negative pressure results in a vacuum flow stabilization in remaining helical chambers, that in turn reduces a vacuum pressure within the single helical chamber.

A fifty-eighth example includes a scalper to be employed in a multi-directional flow filtration system, the scalper comprising a housing, a first scalping section including a first set of scalping walls forming a first plurality of helical chambers, and a second scalping section including a second set of scalping walls forming a second plurality of helical chambers. In such an example, the first and second set of scalping walls extend longitudinally along each of the first scalping section and the second scalping section, respectively. Furthermore, each of the first scalping section and the second scalping section is coupled to the housing such that air is capable of flowing between an interior of the first scalping section, an interior cavity of the housing, and an interior of the second scalping section, and wherein each of the first scalping section and the second scalping section extend away from the housing.

A fifty-ninth example optionally includes the fifty-eighth example, and further includes wherein each of the first scalping section and the second scalping section include first ends and second ends, the first ends for receiving a vacuum or a positive pressure via at least one vacuum generator, and wherein the second ends communicably couple the interior of each of the first scalping section and the second scalping section to the interior cavity.

A sixtieth example optionally includes the fifty-ninth example and/or some other examples herein, and further includes wherein the vacuum and/or the positive pressure is communicated by way of each of the first scalping section and the second scalping section to the interior cavity and to atmosphere by way of a drawing chamber.

A sixty-first example optionally includes any of the aforementioned examples, and further comprises a hollow high pressure bypass port surrounded by the housing and communicably coupled to the interior cavity.

A sixty-second example optionally includes any of the aforementioned examples, and further includes wherein the first and second set of scalping walls form at least two individual helical chambers within the first scalping section and the second scalping section, respectively.

A sixty-third example optionally includes any of the aforementioned examples, and further includes wherein the first scalping section and the second scalping section are at least partially surrounded by the housing. Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

### Terminology

For the purposes of the description, the following terms, phrases, and/or definitions may be applicable to the previously described embodiments.

The phrases “A/B” and “A or B” mean (A), (B), or (A and B), similar to the phrase “A and/or B.” For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element. With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

The present disclosure may use the terms “embodiment” or “embodiments,” each of which may refer to one or more of the same or different embodiments. The present disclosure may use the phrases “in an embodiment,” “in embodiments,” “in some embodiments,” and/or “in various embodiments,” each of which may refer to one or more of the same or different embodiments.

The terms “comprises,” “comprising,” “including,” “having,” and the like, as used with respect to one or more embodiments, are synonymous, are generally intended as “open” terms (e.g., the term “including” should be interpreted as “including but not limited to,” the term “having” should be interpreted as “having at least,” the term “includes” should be interpreted as “includes but is not limited to,” etc.), and specify the presence of stated elements, assemblies, subassemblies, components, features, integers, steps, and/or operations, but do not preclude the presence or addition of one or more other elements, assemblies, subassemblies, components, features, integers, steps, and/or operations, and/or groups or combinations thereof.

The terms “coupled,” “connected,” “communicatively coupled,” along with their derivatives, may be used herein. It should be understood that these terms are not intended as synonyms for each other. “Coupled” may mean that two or more elements are in direct physical or electrical contact with one another, may mean that two or more elements indirectly contact each other but still cooperate or interact with each other, and/or may mean that one or more other elements are coupled or connected between two elements that are said to be coupled with each other. The term “directly coupled” may mean that two or more elements are in direct contact with one another. The term “connected” may be used to indicate that two or more elements are in direct or indirect physical or electrical contact with each other, indicate that two or more elements are in direct or indirect communication with each other. The term “communicatively coupled” or “communicably coupled” may mean that two or more elements may be in contact with one another by a means of communication including through one or more wires, through a wireless communication channel or link, and/or some other interconnect means.

The term “fabrication” refers to the creation of a metal structure using fabrication means. The term “fabrication means” as used herein refers to any suitable tool or machine that is used during a fabrication process and may involve tools or machines for cutting (e.g., using manual or powered saws, shears, chisels, routers, torches including handheld torches such as oxy-fuel torches or plasma torches, and/or computer numerical control (CNC) cutters including lasers, mill bits, torches, water jets, routers, etc.), bending (e.g., manual, powered, or CNC hammers, pan brakes, press brakes, tube benders, roll benders, specialized machine presses, etc.), assembling (e.g., by welding, soldering, brazing, crimping, coupling with adhesives, riveting, using fasteners, etc.), molding or casting (e.g., die casting, centrifugal casting, injection molding, extrusion molding, matrix molding, three-dimensional (3D) printing techniques including fused deposition modeling, selective laser melting, selective laser sintering, composite filament fabrication, fused filament fabrication, stereolithography, directed energy deposition, electron beam freeform fabrication, etc.), and PCB and/or semiconductor manufacturing techniques (e.g., silk-screen printing, photolithography, photoengraving, PCB milling, laser resist ablation, laser etching, plasma exposure, atomic layer deposition (ALD), molecular layer deposition (MLD), chemical vapor deposition (CVD), rapid thermal processing (RTP), and/or the like).

The term “fastener”, “fastening means”, and/or the like refers to an element that mechanically joins or affixes two or more objects together, and may include, for example, threaded fasteners (e.g., bolts, screws, nuts, threaded rods, etc.), pins, linchpins, r-clips, clips, pegs, clamps, dowels, cam locks, latches, catches, ties, hooks, magnets, hinges, molded or assembled joineries, adhesives, and/or the like.

The terms “flexible,” “flexibility,” and/or “pliability” refer to the ability of an object or material to bend or deform in response to an applied force. The term “flexible” is complementary to “stiffness.” The term “stiffness” and/or “rigidity” refers to the ability of an object to resist deformation in response to an applied force. The term “elasticity” refers to the ability of an object or material to resist a distorting influence or stress and to return to its original size and shape when the stress is removed. Elastic modulus (a measure of elasticity) is a property of a material, whereas flexibility or stiffness is a property of a structure or component of a structure and is dependent upon various physical dimensions that describe that structure or component.

The term “wear” refers to the phenomenon of the gradual removal, damaging, and/or displacement of material at solid surfaces due to mechanical processes (e.g., erosion) and/or chemical processes (e.g., corrosion). Wear causes functional surfaces to degrade, eventually leading to material failure or loss of functionality. The term “wear” as used herein may also include other processes such as fatigue (e.g., the weakening of a material caused by cyclic loading that results in progressive and localized structural damage and the growth of cracks) and creep (e.g., the tendency of a solid material to move slowly or deform permanently under the influence of persistent mechanical stresses). Mechanical wear may occur as a result of relative motion occurring between two contact surfaces. Wear that occurs in machinery components has the potential to cause degradation of the functional surface and ultimately loss of functionality. Various factors, such as the type of loading, type of motion, temperature, lubrication, and the like may affect the rate of wear.

The term “circuitry” refers to a circuit or system of multiple circuits configurable to perform a particular function in an electronic device. The circuit or system of circuits may be part of, or include one or more hardware components, such as a logic circuit, a processor (shared, dedicated, or group) and/or memory (shared, dedicated, or group), an Application Specific Integrated Circuit (ASIC), a field-programmable gate array (FPGA), programmable logic device (PLD), System-on-Chip (SoC), System-in-Package (SiP), Multi-Chip Package (MCP), digital signal processor (DSP), etc., that are configurable to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “controller” refers to an element or entity that has the capability to affect a physical entity, such as by changing its state or causing the physical entity to move.

The term “communicating a pressure” refers to a positive pressure with respect to atmospheric pressure and/or a negative pressure with respect to atmospheric air being provided to an area or areas via a source of the positive and/or negative pressure. For example, the area may be one or more helical chambers associated with an end-effector as discussed herein. In another example, the area may refer to a bypass port associated with the end-effector as discussed herein. The source may be a vacuum generator (e.g., ejector or blower), or an air source (e.g., a pump, compressed air source, etc.).

What is claimed is:

1. A scalper to be employed in a multi-directional flow filtration system, the scalper comprising:
a body; and
a set of scalping walls forming a plurality of helical chambers, the set of scalping walls helically extending along at least a portion of an interior of the body in a longitudinal direction.

2. The scalper of claim 1, wherein the set of scalping walls form at least two individual helical chambers.

3. The scalper of claim 1, wherein the set of scalping walls form three individual helical chambers.

4. The scalper of claim 1, wherein each scalping wall of the set of scalping walls is fixed within a scalping section of the scalper.

5. The scalper of claim 1, wherein each helical chamber of the plurality of helical chambers is configured to provide a vacuum force from a first vacuum generator of the vacuum-driven pick and place system to an exterior of the scalper.

6. The scalper of claim 1, wherein the plurality of helical chambers occupy an entirety of an inner diameter of the scalper, along at least the portion of the interior of the body.

7. The scalper of claim 1, further comprising:
a hollow high pressure bypass port configured to receive vacuum or pressurized air provided by a second vacuum generator or compressor, respectively, of the multi-directional flow filtration system.

8. The scalper of claim 7, wherein the hollow high pressure bypass port is at least partially surrounded by the plurality of helical chambers.

9. The scalper of claim 1, further comprising:
a perforated screen positioned proximal to a first end of the plurality of helical chambers, wherein the first end of the plurality of helical chambers is distal to a second end of the plurality of helical chambers, and the second end is proximal to an opening of the scalper.

10. The scalper of claim 9, wherein the perforated screen is removable.

11. A multi-directional flow filtration system, comprising:
a reversible vacuum generator;
a suction mechanism having an external body that surrounds one or more helically elongated members, the one or more helically elongated members forming a plurality of helical chambers that extend helically along a length of the suction mechanism in a longitudinal direction; and
a controller configurable to:
control the reversible vacuum generator to communicate a first negative pressure with respect to atmospheric pressure to the plurality of helical chambers for a first duration,
control the reversible vacuum generator to communicate a first positive pressure to the plurality of helical chambers with respect to atmospheric pressure for a second duration subsequent to the first duration elapsing.

12. The system of claim 11, wherein the one or more helically elongated members further comprise a set of walls that at least in part form the plurality of helical chambers.

13. The system of claim 11, further comprising a bypass port that extends longitudinally along the length of the suction mechanism and within an interior of the external body.

14. The system of claim 13, wherein the bypass port is at least partially surrounded by the one or more helically elongated members.

15. The system of claim 13, further comprising a pressurized air source; and
wherein the controller stores further instructions to supply pressurized air to the bypass port while the reversible vacuum generator is communicating the first positive pressure to the plurality of helical chambers, responsive to one or more predetermined conditions being met for supplying pressurized air to the bypass port.

16. The system of claim 15, wherein the one or more predetermined conditions include an indication that the suction mechanism is at least partially obstructed.

17. A method of passively screening and ejecting a contaminating material from a scalper employed in an open-loop multi-directional flow filtration system, the method comprising:
applying a negative pressure via a reversible vacuum generator to an interior of the scalper, the interior of the scalper including a drawing chamber proximal to atmosphere and a scalping section positioned between the drawing chamber and the reversible vacuum generator, wherein the scalping section includes a plurality of scalping walls which together form a plurality of helical chambers, each of the plurality of helical chambers having an open aperture cross-sectional area;
after a first predetermined duration, stopping application of the negative pressure; and
applying, after stopping the application of the negative pressure, a positive pressure via the reversible vacuum generator to the interior of the scalper for a second predetermined duration,
wherein the negative pressure traps the contaminating material within a single helical chamber of the plurality of helical chambers, and
wherein the positive pressure contributes to dislodging the contaminating material from the single helical chamber and ejecting the contaminating material from the scalper to atmosphere.

18. The method of claim 17, further comprising:
applying the negative pressure for the first predetermined duration and then applying the positive pressure for the second predetermined duration in a cycle that repeats any number of times.

19. The method of claim 17, wherein the negative pressure traps the contaminating material within the single helical chamber under conditions where the contaminating material is of a cross-sectional area that is less than the open aperture cross-sectional area of any one of the plurality of helical chambers.

20. The method of claim 19, wherein the contaminating material comprises a rigid, non-malleable material; and
wherein trapping the rigid, non-malleable material is a function of one or more of a helix pitch of the single helical chamber and a convex-to-length ratio of the rigid, non-malleable material, and a collision force between the rigid, non-malleable material and a scalping wall of the single helical chamber.

21. The method of claim 19, wherein the contaminating material comprises a malleable material; and
wherein trapping the malleable material is a function of one or more of a friction resistance between the malleable material and a scalping wall of the single helical chamber that increases as the malleable material elongates within the single helical chamber, and a dynamic impact between the malleable material and the scalping wall.

22. The method of claim 17, wherein trapping the contaminating material within the scalping section prevents the contaminating material from reaching and clogging a screen positioned within the interior of the scalper between the scalping section and the reversible vacuum generator, or, in an absence of the screen, from being drawn into the open-loop multi-directional flow filtration system upstream of the scalper.

23. The method of claim 17, wherein inverting flow through the interior of the scalper via stopping applying the negative pressure and then applying the positive pressure produces a pull force on the scalping section as a result of an induced pressure difference in the drawing chamber, the pull force on the scalping section serving to encourage the contaminating material to be dislodged from the single helical chamber and then ejected from the scalper.

24. The method of claim 17, further comprising:
supplying a positive pressurized air flow from an air source to the drawing chamber by way of a bypass port that bypasses the scalping section, the positive pressurized air flow causing an increase in the pull force on the scalping section that in turn serves to further encourage the contaminating material to be dislodged from the single helical chamber and then ejected from the scalper.

25. The method of claim 17, wherein applying the positive pressure via the reversible vacuum generator produces an impact force on the contaminating material that encourages the contaminating material to dislodge from the single helical chamber and be ejected from the scalper.

26. The method of claim 17, wherein trapping the contaminating material within the single helical chamber during the applying of the negative pressure results in a vacuum flow stabilization in remaining helical chambers, that in turn reduces a vacuum pressure within the single helical chamber.

27. A scalper to be employed in a multi-directional flow filtration system, the scalper comprising:
a housing;
a first scalping section including a first set of scalping walls forming a first plurality of helical chambers; and
a second scalping section including a second set of scalping walls forming a second plurality of helical chambers,
wherein the first and second set of scalping walls extend longitudinally along each of the first scalping section and the second scalping section, respectively;
each of the first scalping section and the second scalping section coupled to the housing such that air is capable of flowing between an interior of the first scalping section, an interior cavity of the housing, and an interior of the second scalping section;
and
wherein each of the first scalping section and the second scalping section extend away from the housing.

28. The scalper of claim 27, wherein each of the first scalping section and the second scalping section include first ends and second ends, the first ends for receiving a vacuum or a positive pressure via at least one vacuum generator or compressor, respectively; and
wherein the second ends communicably couple the interior of each of the first scalping section and the second scalping section to the interior cavity.

29. The scalper of claim 28, wherein the vacuum and/or the positive pressure is communicated by way of each of the first scalping section and the second scalping section to the interior cavity and to atmosphere by way of a drawing chamber.

30. The scalper of claim 27, further comprising a hollow high pressure bypass port surrounded by the housing and communicably coupled to the interior cavity.

31. The scalper of claim 27, wherein the first and second set of scalping walls form at least two individual helical chambers within the first scalping section and the second scalping section, respectively.

32. The scalper of claim 27, wherein the first scalping section and the second scalping section are at least partially surrounded by the housing.
